(19) United States
(12) Patent Application Publication
(10) Pub. No.: US 2019/0330843 A1
(43) Pub. Date: Oct. 31, 2019

(54) CONSTRUCTION APPARATUS AND METHOD

(71) Applicant: Marcel Eric MOROKUTTI, Seaforth (AU)

(72) Inventor: Marcel Eric MOROKUTTI, Seaforth (AU)

(21) Appl. No.: 16/311,155

(22) PCT Filed: Jun. 19, 2017
(86) PCT No.: PCT/AU2017/050615

§ 371 Date: Dec. 18, 2018

(30) Foreign Application Priority Data
Jun. 19, 2016 (AU) 2016902388

(51) Int. Cl. E04B 2/70; B27M 3/00

(52) U.S. Cl. CPC E04B 2/702; E04F 13/077; B27M 3/0066

(57) ABSTRACT

The invention relates to a construction apparatus with a first and second construction part each including a receiving portion. An interlocking means is included, adapt to be received in the receiving portions of the first and second construction parts when put together to maintain the first panel and second panel together. The invention relates to a construction apparatus made of bamboo. The invention also relates to methods of use of the invention. The invention also relates to an engineered bamboo panel.

### FIELD OF THE INVENTION

The present invention relates to a construction apparatus.

### BACKGROUND OF THE INVENTION

Bamboo is an amazing natural material. Bamboo, being related to grass, grows very quickly, with strong, straight, fibrous canes that can be grown easily on an industrial scale. Canes can be harvested without the need to cut down the whole plant, unlike trees and so a bamboo crop can be grown, sustainably, and economically. Due to this there has long been a desire to be utilise bamboo in construction, as a useful and environmentally friendly alternative. Concrete and other manmade materials have a high carbon footprint and require a disproportionate amount of energy to produce.

Bamboo flooring is known, and popular due to sustainability of growing the bamboo and reduced energy use in production of the flooring. Bamboo panels are made from the bamboo fibres formed into planks with pressure and glue. There are various methods, each producing a useful and tough plank of material suitable for use as flooring.

Until now, there has been no advancement in use of the bamboo planks or panels, and methods of construction which would enable the bamboo material to be used as a construction block for walls, as well as floors, and ceilings. Standards for building materials are rightly very high, and as such it has been difficult to make use of bamboo as a construction material.

The inventor, has through prolonged research and development, invented a completely new construction block, and method of construction that can utilise the bamboo sheets. The invention is an exciting step forward and likely to be highly desirable to the construction and renovation markets, once they become aware of this new innovation. The resultant construction is simple to use, strong, durable, and can be provided in a very wide range of aesthetic finishes. The method of use is such that home DIY enthusiasts may consider adding a feature dividing wall using the blocks and method as it can be readily installed with little prior skill or knowledge. In the main, it is hoped that many homes will now be able to be designed and constructed using environmentally friendly and sustainably grown bamboo, through use of this significant new invention.

The invention is subject of Australian provisional patent application no. 2016902388, dated 19 Jun. 2016, the contents of which is incorporated herein.

The following describes a non-limiting example of the invention being used as a construction apparatus of bamboo, as a particular useful and beneficial form of the invention. Other materials may be used instead, and it is not intended to limit the invention entirely to bamboo, other than as defined in the claims. For example, timber or plywood, may be used, or in fact any suitable material.

For clarity, any prior art referred to herein, does not constitute an admission that the prior art forms part of the common general knowledge in Australia or elsewhere.

It is an object of the present invention to provide a construction apparatus that at least ameliorates one or more of the aforementioned problems of the prior art. It is a further object of the present invention to provide a bamboo construction apparatus that at least ameliorates one or more of the aforementioned problems of the prior art. It is another object of the invention to provide a method of use of a construction apparatus that at least ameliorates one or more of the aforementioned problems of the prior art. It is a further object of the invention to provide a method of use of a bamboo construction apparatus that at least ameliorates one or more of the aforementioned problems of the prior art.

### DISCLOSURE OF THE INVENTION

Accordingly, the present invention provides a construction apparatus for building, the construction apparatus including:
a first construction part including a receiving portion;
a second construction part, including a receiving portion;
an interlocking means, adapt to be received in the receiving portions of the first and second construction parts when put together,
   wherein the interlocking means maintains the first construction part and second construction part together.

The construction apparatus may take any suitable form, for example as part of a wall, ceiling truss or in fact any suitable construction. The construction apparatus may be used for interiors. The construction apparatus may be used for exterior constructions. The construction apparatus may be used for any construction chosen from the group: domestic; commercial; industrial; educational; mining; shipping; or scientific and research based.

The building may be a new construction. The building may be a renovation or repair. The building may be any suitable construction. The building may be a domestic, commercial or industrial building.

Preferably, at least part of the apparatus is made of bamboo. Preferably, one or more construction part is made of bamboo. Preferably, the first construction part is made of bamboo. Preferably, the second construction part is made of bamboo. Preferably, both the first and second construction parts are made of bamboo. The interlocking part may be made of bamboo. Preferably, the construction apparatus is made substantially of bamboo.

Preferably, the bamboo used is bamboo sheeting. Preferably, the bamboo used is an engineered bamboo material. Preferably, the bamboo is an engineered bamboo sheet. Preferably, the bamboo sheet is a strong flexible material. Preferably, the engineered bamboo sheet is strong and flexible, and highly adapted for use in the construction industry. Preferably, an engineered bamboo sheet is used, including layers. The layers may take any suitable form. Preferably, the layers of formed with bamboo fibres substantially aligned in the same direction. Preferably, engineered bamboo sheet includes an arrangement of thin layers of bamboo fibres arranged to give the material particular strength for construction. Preferably, three or four layers are included. Preferably, three layers are used. Preferably, the layers are thin layers. Preferably, the layers are substantially 6 millimetres thick. Preferably, the resultant sheet is very thin, but strong and flexible. Most preferably, three layers are included. Most preferably, three layers are included, the central layer having vertical bamboo fibres, the outside two layers having horizontal fibres, wherein a very strong flexible bamboo sheet is created suitable for use in construction. In other use the arrangement of fibres may be reversed with the central layer having horizontal bamboo fibres and the outer two layers having bamboo fibres in the vertical direction. Combinations of materials may be used so that one or more layer may include non-bamboo material, for example.

The interlocking means may be made of bamboo, configured to strongly resist damage in all directions. The interlocking means may be made of alternate materials. The interlocking means may be made of timber, wood or an artificial composite material. Any suitable bamboo or bamboo composite material may be used instead.

In alternative forms of the invention, the construction apparatus may be made of any suitable material. The construction apparatus may be made of timber. The construction apparatus may include engineered sheets of material. The engineered sheets may include any suitable combination of materials.

The first construction part may take any suitable form. The first construction part may be a sheet of material. Preferably, the first construction part is formed of layers. Preferably, three layers of material are included, a core and two outer layers surrounding the core. The core may be substantially 6 millimetres in diameter. Any suitable core thickness may be used. Each of the outer layers may be substantially 6 millimetres in diameter. Any suitable outer thickness layers may be used. Preferably, the first construction part is a thin sheet of material. Preferably, the first construction part is a sheet of thin, light weight material that is strong and flexible and useful for construction. Preferably, the overall thickness of the sheet is substantially 18 millimetres. Preferably, the bamboo sheet contains layers of bamboo fibres in different directions. Preferably, the bamboo sheets contains a plurality of layers of bamboo fibres in different directions. Preferably, the first construction part contains layers of fibres of different directions. Preferably, these are bamboo fibres, some running horizontally in one layer and some running vertically in another layer.

Preferably, the first construction part is an engineered bamboo sheet of a core of substantially 6 millimetres thickness with vertical bamboo fibres surrounded by two outer layers of substantially 6 millimetres thickness of horizontal bamboo fibres.

Preferably, the first construction part is sheet of bamboo material. Preferably, the bamboo sheet is an engineered bamboo sheet. Most preferably, the first construction part is a sheet of engineered bamboo material, according to the invention.

The second construction part may take any suitable form. The second construction part may be a sheet of material. Preferably, the second construction part is formed of layers. Preferably, three layers of material are included, a core and two outer layers surrounding the core. The core may be substantially 6 millimetres in diameter. Any suitable core thickness may be used. Each of the outer layers may be substantially 6 millimetres in diameter. Any suitable outer thickness layers may be used. Preferably, the second construction part is a thin sheet of material. Preferably, the second construction part is a sheet of thin, light weight material that is strong and flexible and useful for construction. Preferably, the overall thickness of the sheet is substantially 18 millimetres. Preferably, the bamboo sheet contains layers of bamboo fibres in different directions. Preferably, the bamboo sheets contains a plurality of layers of bamboo fibres in different directions. Preferably, the first construction part contains layers of fibres of different directions. Preferably, these are bamboo fibres, some running horizontally in one layer and some running vertically in another layer.

Preferably, the second construction part is an engineered bamboo sheet of a core of substantially 6 millimetres thickness with vertical bamboo fibres surrounded by two outer layers of substantially 6 millimetres thickness of horizontal bamboo fibres.

Preferably, the second construction part is sheet of bamboo material. Preferably, the bamboo sheet is an engineered bamboo sheet. Most preferably, the second construction part is a sheet of engineered bamboo material, according to the invention.

Preferably, the first and or second construction parts are substantially rectangular panels. Preferably, the first and second construction parts are the same as one another, in order that repeating parts may be used to create a wall. Preferably, a plurality of the first construction parts, and a plurality of second construction parts form either side of a wall with a cavity between. The first and second construction parts may be any suitable dimensions, depending on the use and application. Full, half, three quarter or quarter sized parts may be provided to create a construction of the desired dimensions, in the usual fashion. In other words, the first construction part in full sized may be attached to a second construction part, either being full, three quarter or quarter sized, and a corresponding sized first construction part is spaced apart from the first and attached to a second construction part, the two first construction parts corresponding one to the other and the second construction parts corresponding one with the other. Blocks are formed with corresponding first construction parts attached to corresponding pairs of second construction parts. Each part may be added separately, or together, depending on the method of construction used. It is possible some preformed sections may be supplied in some uses of the invention. However, it is envisaged that the invention will be supplied as a full disassembled product to be assembled in location. It is an advantage of the invention that the construction parts and interlocking means can be packed, or flat packed conveniently for transportation.

Preferably, the first construction part is a substantially rectangular planar panel with a first end, second end, top surface and lower surface. Any suitable planar shape may be used instead. Preferably, the second construction part is a substantially planar panel with a first end, second end, top surface and lower surface. Each of the panels may be used together with other panels secured together through use of the interlocking means in the receiving portions. Preferably, each end includes receiving portions for receipt of an interlocking means whereby a plurality of panels may be attached together. Most preferably, front and back panels are used, and these attach to corresponding parts to make “blocks” of the wall.

Preferably, tongue and groove connection is used between parts. Most preferably, each of the first construction part and second construction part include a tongue at either the top or lower edge and a corresponding groove at the appropriate top or lower edge. For example, a first construction part and second construction part may have a groove at the upper edge adapted to receive the “tongue” of another similar first or second part where by a further row of first and second construction parts may be created by putting the tongue in the groove in the usual manner. Adhesive may be applied to hold the assembled tongue and groove panels together. In this manner rows of the construction apparatus can be constructed vertically and horizontally to the desired level.

The receiving portion of the first construction part or the second construction part may take any suitable form. Preferably, the receiving portions of the first construction part is adapted to be in an end. Preferably, the receiving portion lies in at least on end of the first construction part. Preferably, the receiving portion runs substantially the length of the at least one end of the first construction part, open to the top surface of the first construction part and to the lower surface of the first construction part. Preferably, the first construction part has receiving portions in both ends. Preferably, the receiving portion in a first end of the first construction part is substantially a mirror image of a receiving portion formed in the other end. Where the first construction part and the second construction part are the same as one other these will then join, through use of the interlocking means to form the surface.

Preferably, the receiving portions of the second construction part is adapted to be in an end. Preferably, the receiving portion of the second construction part lies in at least on end of the second construction part. Preferably, the receiving portion runs substantially the length of the at least one end of the second construction part, open to the top surface of the second construction part and to the lower surface of the second construction part. Preferably, the second construction part has receiving portions in both ends. Preferably, the receiving portion in a first end of the second construction part is substantially a mirror image of a receiving portion formed in the other end.

Preferably, the receiving portion is a trapezoid shape. Preferably, the receiving portion of the first or second end is a trapezoid shape. Preferably, the receiving portions at either end to a part are substantially mirror images to one another. Preferably, together the receiving portions form a “bow-tie” shape.

Preferably, when a first end of the first construction part and second end of a second construction part are put together the receiving portions in the ends together form a combined receiving portion for receipt of the interlocking means. Preferably, when a first end of the first construction part and second end of a second construction part are put together the receiving portions in the ends line up to form a combined receiving portion for receipt of the interlocking means. Preferably, the combined receiving portion shape as viewed from above is substantially the same shape in cross-section of the interlocking means.

Preferably, the combined shape of the reciprocating means is substantially a “bow-tie” shape. In other forms of the invention any suitable shape may be used. The use of the “bow-tie” or dovetail arrangement is useful as it strongly resists removal in the horizontal direction, after being put in position as described below. The fanning out shaped resists pulling apart, until the interlocking means is removed.

Preferably, the shape of the receiving portion is such that it has the same cross-sectional shape that runs along the entire open end of the part. In this way the reciprocating shape of the corresponding receiving portion to which it abuts together form a channel. It is into this channel that the interlocking means, or “key” is used to hold together. The receiving portion shape repeats as more first and second construction parts are added to create a wall, sheet or surface. As can be readily imagined, repeats of first and second parts, including spaced apart from one another assist to form the cavity wall.

Preferably, the receiving portion of the first construction part and the receiving portion of the second construction part are mirror images of one another. The shapes could be other than mirror image shapes, provided the repeats match the shape of the interlocking means to be used, in other forms of the invention. Use of the mirror image, repeating corresponding shape across the parts of the apparatus is useful as it enables any part to be attached to any other part by putting the two reciprocating receiving portions together. The first construction part and the second construction part may be the same as one another. The first construction part and the second construction part may be different to one another, for example full panel sized or a smaller size to complete the edge of the wall. Also corner pieces or shaped construction parts may be included as well as straight parts for either the first or second construction part.

Preferably, the interlocking means is configured to fit into the receiving portions of the first and second part together, whereby the parts are held together strongly. Preferably, the interlocking part is substantially the same shape in cross-section as the combined receiving portions of the first and second parts. Preferably, the receiving portions together form a channel in the ends of abutting first and second construction parts such that application of the interlocking part holds them together. Preferably, the interlocking means may be applied into the channel during construction to hold the first and second parts together. Preferably, a channel is formed by the abutting receiving portions such that the interlocking means may be slid in from above, to join the parts together. Preferably, a plurality of first and second parts are used with a plurality of interlocking means used to hold these together. Preferably, once the “key” is in place in the receiving portions strongly resist being pulled apart in the horizontal direction. Preferably, once the interlocking means is in the receiving portions the interlocking means strongly resists the pulling apart of the first and second construction parts. The interlocking means may resist forces in any suitable direction. Preferably, the interlocking means resists the parting of the construction parts one from the other. The interlocking means may resist the separation of the construction parts in any suitable direction. Preferably, the interlocking means resists forces in the horizontal direction, for example pulling apart, and in the vertical direction, the snug fit of the key in the lock assists to maintain the panels in place. The interlocking means may be removed and the first and second construction parts separated.

Preferably, the interlocking means maintains the first construction part and the second construction part together until the interlocking means is removed. The apparatus may be used in a versatile application where changes may be made after installation through removal of the interlocking means and changing the configuration. In this case adhesive will not be used, see the standard application mentioned below.

Most preferably, each end of the first construction part or the second construction part includes receiving portions, which when aligned with a corresponding receiving portion can be joined to other first or second construction parts by application of an interlocking means at each end of the panel. Most preferably, a plurality of blocks, rows and repeats are used to create a construction of a suitable size.

Most preferably, the interlocking means strongly maintains the first construction part and second construction part together, suitable for use in construction. Most preferably, the strong attachment maintains panels formed of the first construction part and second construction part together to form a construction.

Preferably, a pair of first construction parts are used attached to corresponding second construction parts through use of the interlocking means. In this form of the invention a cavity wall and “blocks” of inventive construction are formed, which may include one or more spacers. Spacers may be included adapted to sit at right-angles to the pair of first or second construction parts, in the nature of strut. The spacer resists against either pair of parts moving together and closing the predetermined space. The spacer may take any suitable form. Preferably, the space is a substantially rectangular shape, of the same width as the desired width of the cavity of the wall. Preferably, the spacer assists in construction of one row upon another. Preferably, the spacer is sized to be somewhat taller than the height of the first or second part so that once in place between the pair part of the spacer projects.

In a favoured form of the invention, the inside surface of the pairs of parts include corresponding grooves to receive an adapted tongue of the side edges of the spacer. Preferably, during assembly the spacers are slid into the grooves to provide structural support for the pairs of parts. Part of the spacer projects above the top edge of the parts. Preferably, a further part may then be slid with the tongue of the space into the groove. The overlapping parts assist to provide strength to the overall construction. The extending spacer enables the next part is held in place before use of the interlocking means to lock in place. The other side can be put in place, and are held before being locked in, as referred to in greater detail below.

Preferably, the spacers are made of bamboo. Preferably, the spacers are made of bamboo sheet. Preferably, the bamboo sheet is the engineered bamboo sheet described elsewhere.

Preferably, the grooves of the parts or spacers of the invention are formed within the layer of bamboo material that has vertical fibres. Preferably, the tongues of the parts or spacers of the invention are formed within the layer of bamboo material that has vertical fibres.

The first construction part or second construction part may be adapted as a corner piece. In this case the right-angle connection point of their reciprocating ends are adapted to form the receiving portion. Preferably, the interlocking means used through is the same for all connections. The interlocking means for the corner pieces, could, however be different.

A decorative finish may be applied to the surface of the finished construction. The decorative finish may be chosen from the group: coating; lacquer; paint; stain; or varnish. Where bamboo is used the material is attractive in itself and it is advantage of the invention that a simple finish to the natural material will be sufficient to be aesthetically pleasing. A cover, such as a splash back or other layer of material could be applied if the use, called for the material to be protected in some way, or if a different finish was desired.

Where a cavity is created, as in a preferred form of the invention, the cavity may be used to contain other materials. Insulation may be included. Insulation may be included in the cavity. Any suitable insulation may be used as would be understood by the person skilled in the art.

Most preferably, use of the interlocking means prevents disassembly of the first construction part and second construction part until the interlocking means is removed, or the construction destroyed. Most preferably, the interlocking means is a part applied in the vertical plane that substantially prevents disassembly in the horizontal plane. Other arrangements or orientations may be used instead.

Preferably, a plurality of first and second construction parts are used to create rows which are then repeated to build a construction of a suitable size for use.

Preferably, the construction may be tied into a conventional footing, such as a concrete footing or metal posts. Preferably, the construction apparatus may be used in place of conventional concrete, brick, wood or similar constructions. The construction apparatus may be tied in to a footing in any suitable manner as would be understood by a person skilled in the art. In some use glue and conventional fixing may be used instead, to attach the bottom layer of the construction to a floor.

Preferably, the uppermost row of the construction apparatus is adapted accordingly. Preferably, the lower most row of the construction apparatus is adapted accordingly. The adaptation may be any suitable adaptation to assist the use of the construction with other constructions, such as a floor or ceiling.

A capping piece may be included to cap the uppermost edge of a construction built from the apparatus. A metal plate may be used to attach to tie in apparatus. The capping piece may cover the attachments.

Accordingly, the present invention provides a construction apparatus including:
a first construction part including a receiving portion, the first construction part being made substantially of bamboo;
a second construction part, including a receiving portion;
an interlocking means, adapt to be received in the receiving portions of the first and second construction parts when put together,
   wherein the interlocking means maintains the first panel and second panel together.

The second construction part may also be made of bamboo. The interlocking part may also be made of bamboo. Any or all of the apparatus may be made of bamboo. Preferably, substantially the construction apparatus includes one or more panel of engineered bamboo material and the interlocking means joins the panels strongly together. Preferably, a plurality of construction parts are used to create a construction substantially made of bamboo.

Accordingly, the invention also provides a method of use of a construction apparatus, each construction apparatus including, a first construction part including a receiving portion, a second construction part including a receiving portion, and an interlocking means, the method of use including the following steps:—
a) aligning a receiving part of the first construction part with a receiving part of second construction part to create a receiving channel;
b) putting the interlocking part into the receiving channel, and
c) repeating steps a) and b) with further first and second construction parts until the construction has been built,
   whereby the first and second construction parts are held together.

Accordingly, the invention also provides a method of use of a construction apparatus, each construction apparatus including, a first construction part including a receiving portion, the first construction part being made substantially of bamboo, a second construction part including a receiving portion, and an interlocking means, the method of use including the following steps:—
a) aligning a receiving part of the first construction part with a receiving part of second construction part to create a receiving channel;
b) putting the interlocking part into the receiving channel, and
c) repeating steps a) and b) with further first and second construction parts until the construction has been built,
   whereby the first and second construction parts are held together.

The methods may include a step before step a) of placing a pair of first construction parts in a spaced arrangement, whereby a “block” is created. Blocks may be repeated in either the vertical, or horizontal directly with use of more first and second construction parts. In this way a wall may be built of any suitable size.

Preferably, a further step is included to add a spacer means between the spaced apart parts. The spacer may be connected to the parts. Preferably, the spacer means is connected to the spaced apart parts using tongue and groove. Preferably, the spacer is slid into grooves included on the inner surfaces of the parts. Preferably, the spacer means assists in the structural strength of the construction. Preferably, the spacer means extends above the top edge of the first or second part during assembly whereby a second first or second part may be slid thereon, which assists to hold the assembly together, row on row, before application of the interlocking means.

Preferably, the method is repeated to create rows of blocks to a suitable dimensions. Corner pieces may be attached in the same manner to the ends of the created wall. A tie down may be used to tie into a traditional footing. A metal cap may be used to tie though the construction to a metal footing.

Accordingly, the invention also includes a construction as made with any of the methods of the invention. The construction apparatus of the methods may be the construction apparatus of the invention in any of its forms or variants.

The invention also provides an engineered bamboo panel. Preferably, the engineered bamboo panel is formed of bamboo fibres fixed into a sheet. Preferably, the engineered bamboo panel includes 3 layers, two central layers having bamboo fibres orientated either horizontally or vertically and the outer layers, surrounding these central layers having bamboo fibres orientated in other direction. Most preferably, the central core of the bamboo panel has vertical fibres surround by two other layers of horizontal fibres. Preferably, the bamboo sheet is used for the first and or construction part of the invention. Preferably, the bamboo sheet is use for the construction parts of the methods of the invention.

Preferably, the engineered bamboo panel may be used for the construction apparatus invention in any of its forms or variants. Preferably, the engineered bamboo panel is used for the construction apparatus or any of the methods of the invention.

### INDUSTRIAL APPLICABILITY

The construction apparatus can be produced commercially in parts, and provided to constructions companies, wholesalers or retailers to ultimately be sold to customers. The assembled construction apparatus of the methods may be used in any suitable domestic or commercial construction.

### BRIEF DESCRIPTION OF THE DRAWINGS

The invention will now be described in connection with a non-limiting preferred embodiment with reference to the accompanying drawings, in which:

FIG. 1 is a perspective view from above of a wall built according to a preferred embodiment of the invention;

FIG. 2 is a view from above of the wall of FIG. 1 showing the internal structure, including corner pieces;

FIG. 3 is an end view of the wall of FIGS. 1 and 2;

FIG. 4 is front view of the wall of FIGS. 1 to 3;

FIG. 5 is a schematic perspective view of a section of wall of FIGS. 1 to 4;

FIG. 6 is a schematic end view of the wall of the section of wall of FIG. 5;

FIG. 7 is a schematic front view of the section of wall of FIGS. 5 and 6;

FIG. 8 is a is schematic view from above of the section of wall of FIGS. 5 to 7;

FIG. 9 is a detailed view from above of a corner piece of FIGS. 1 to 8;

FIG. 10 is a capping part of used in FIG. 11;

FIG. 11 is an example of a tied down section of wall, of the invention of FIGS. 1 to 8;

FIG. 12 is a perspective sketch of a block of the invention, of FIG. 1 being formed, showing the interlocking tongue and grooves, to attach panels, spacers and the interlocking receiving part;

FIG. 13 is a detailed perspective view of the interlocking receiving part and grooves of FIG. 12;

FIG. 14 is a detailed perspective view of the corner piece and interlocking receiving parts;

FIG. 15 is a view from above of a corner panel of the wall of FIGS. 1 to 13 illustrating the cut-out receiving part, and groove part of the tongue and groove construction;

FIG. 16 is a view from above of a panel of the wall of FIGS. 1 to 13 illustrating the cut-out receiving part, and groove part of the tongue and groove construction;

FIG. 17 is a view from above of another panel of the wall of FIGS. 1 to 13 illustrating the cut-out receiving part, and groove part of the tongue and groove construction;

FIG. 18 is a plan view of the interlocking part, used in the cut-outs of FIGS. 1 to 17;

FIG. 19 is a perspective view of the interlocking part of FIG. 18;

FIG. 20 is a plan view of the panel of FIG. 16 and the panel of FIG. 17, being put together as during construction;

FIG. 21 is a plan view of the panels of FIG. 20 abutting one with the other;

FIG. 22 is the plan view of the panels of FIG. 21 with the interlocking part pushed into the receiving channel to hold the panels strongly together;

FIG. 23 is a plan view of the corner panel of FIG. 15 with a corresponding other corner panel being put together as during construction;

FIG. 24 is a plan view of the corner panels of FIG. 23 abutting one with the other, at a right-angle;

FIG. 25 is the plan view of the abutting panels of FIG. 24 with the interlocking part pushed into the receiving channel, to hold them strongly together;

FIG. 26 to FIG. 41 show a sequence of perspective schematic views of using the preferred embodiment of FIGS. 1 to 25, to build a wall.

### DETAILED DESCRIPTION OF THE INVENTION INCLUDING A BEST MODE

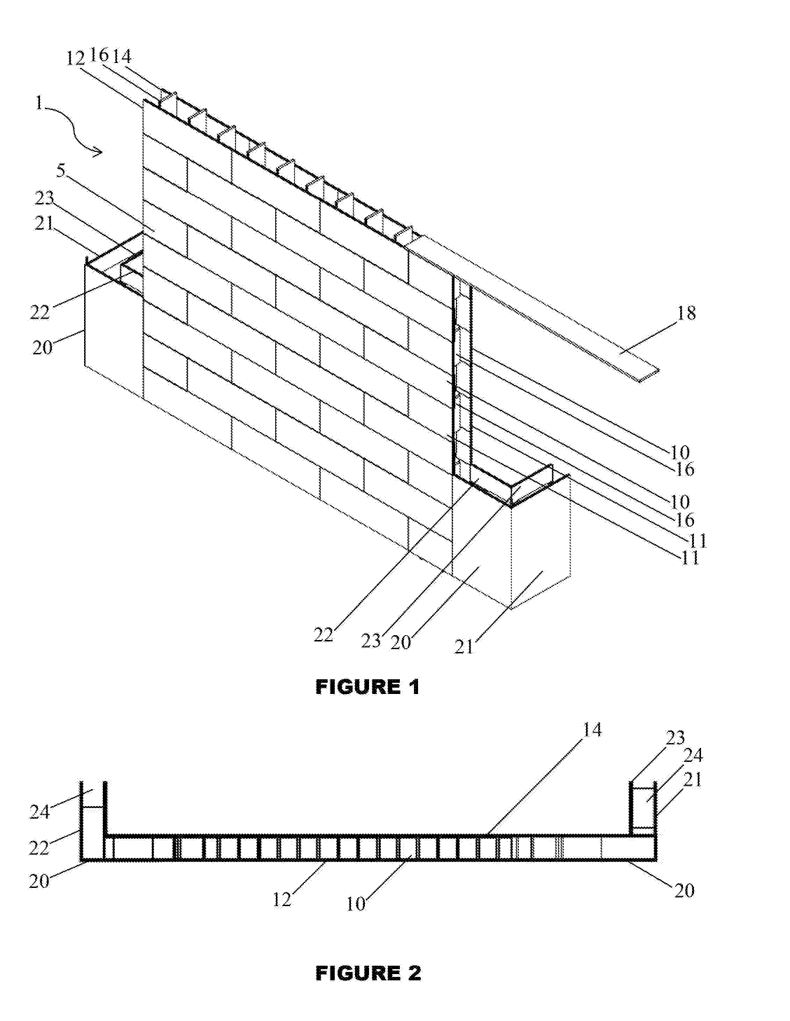

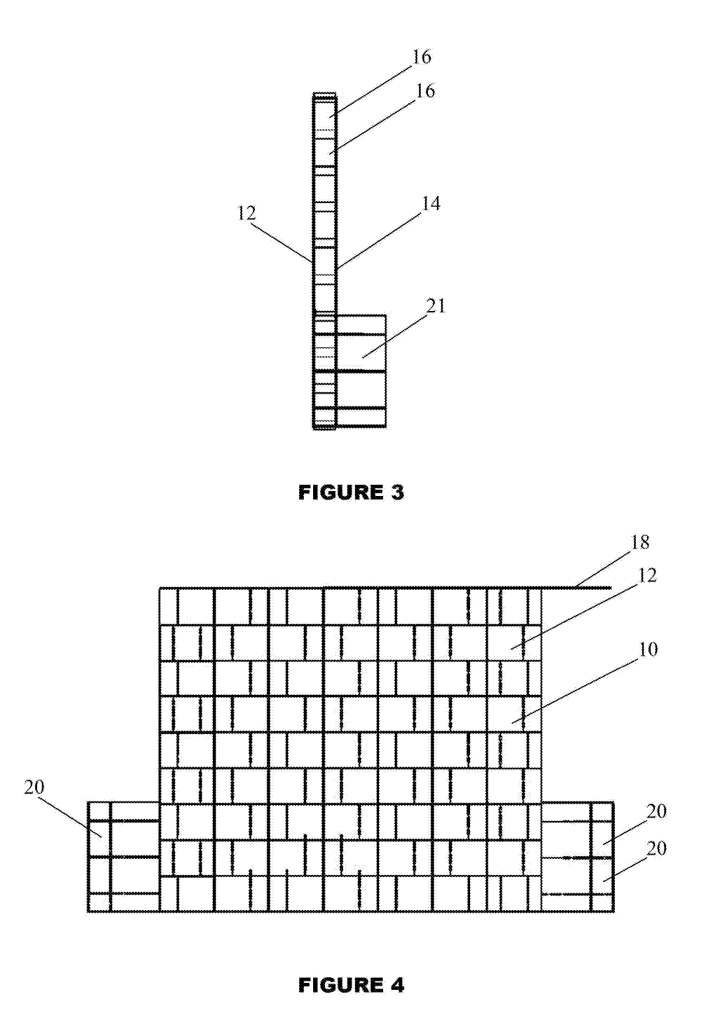

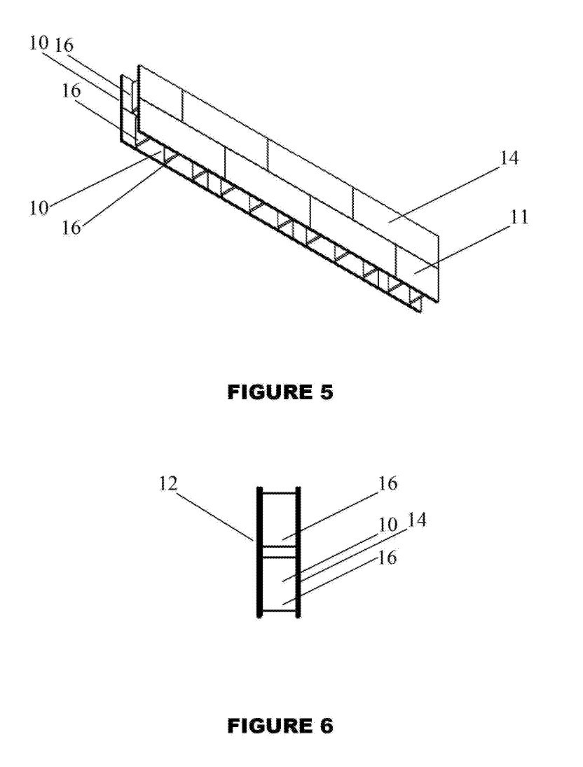

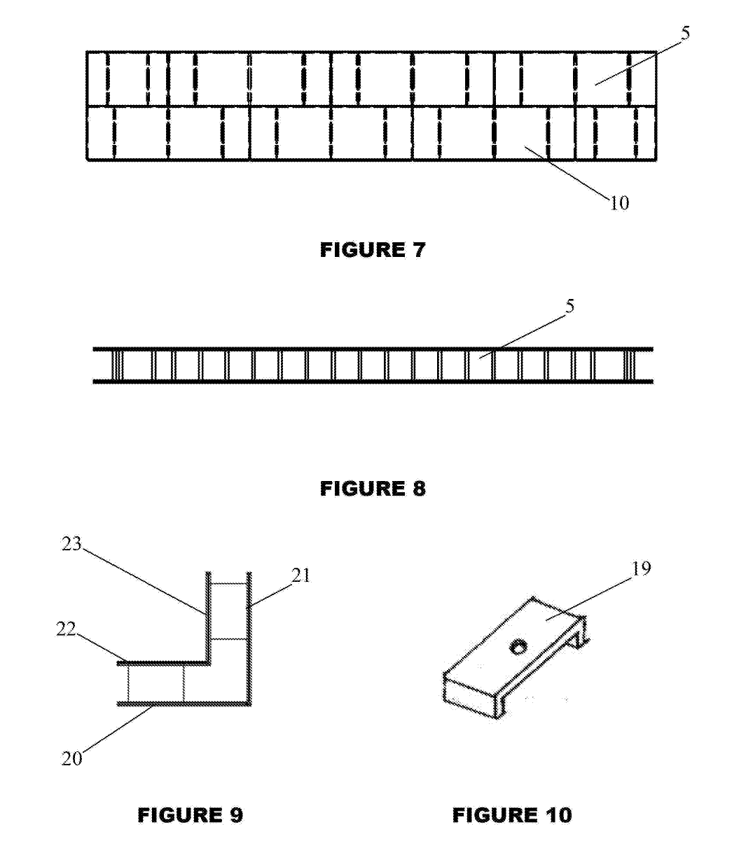

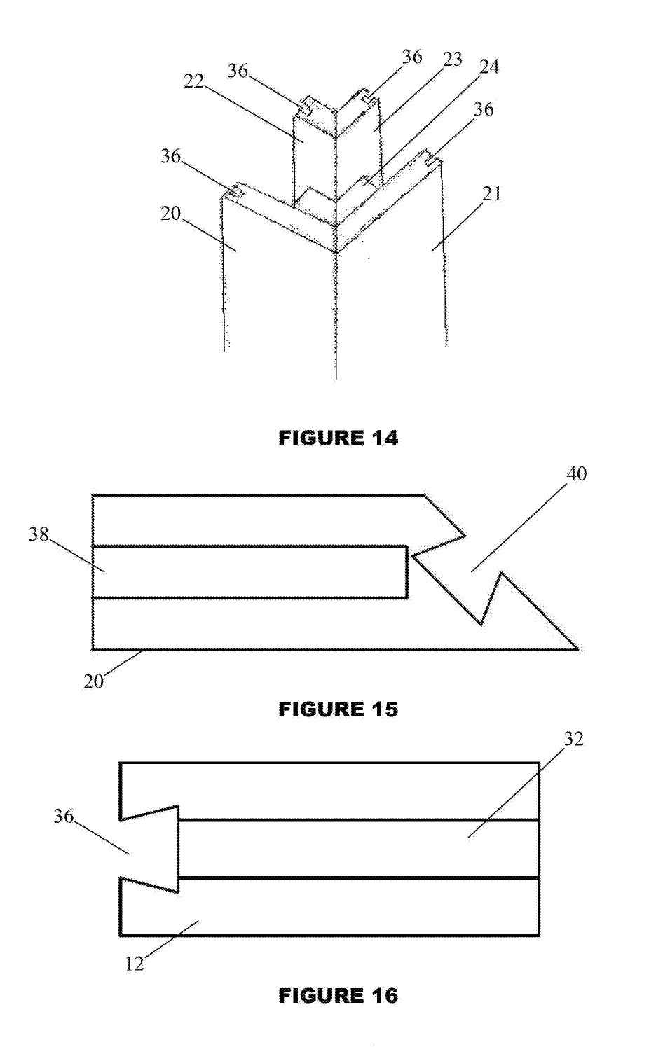

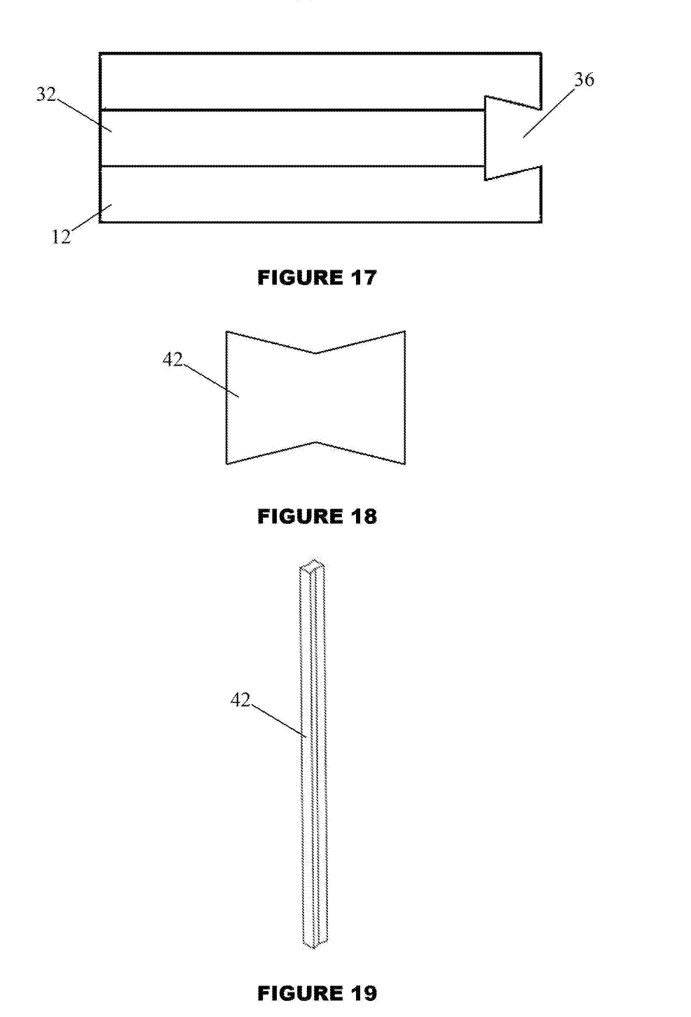

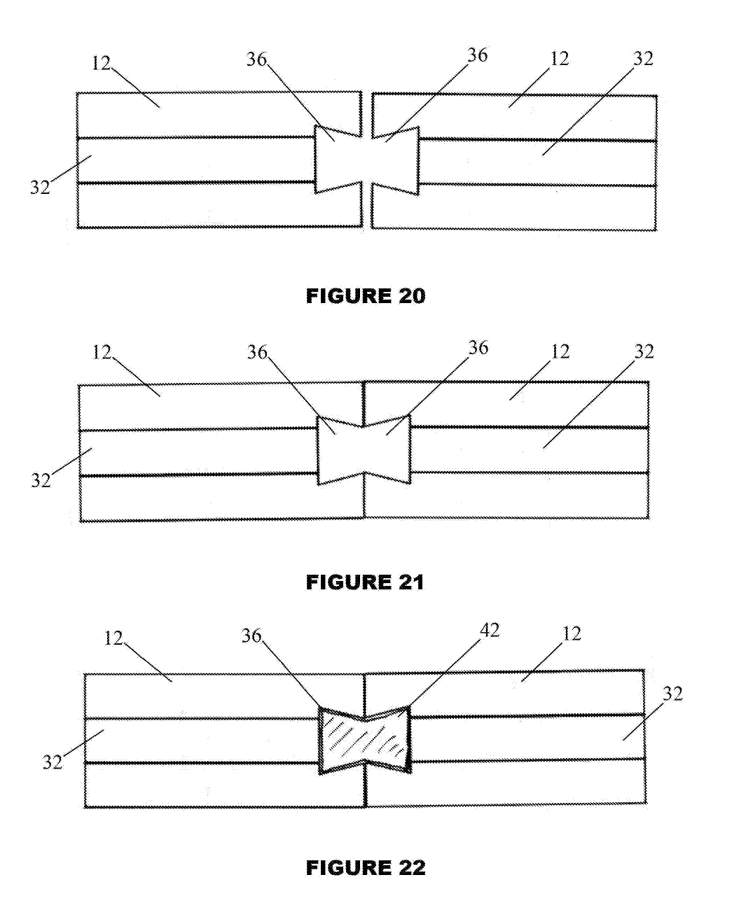

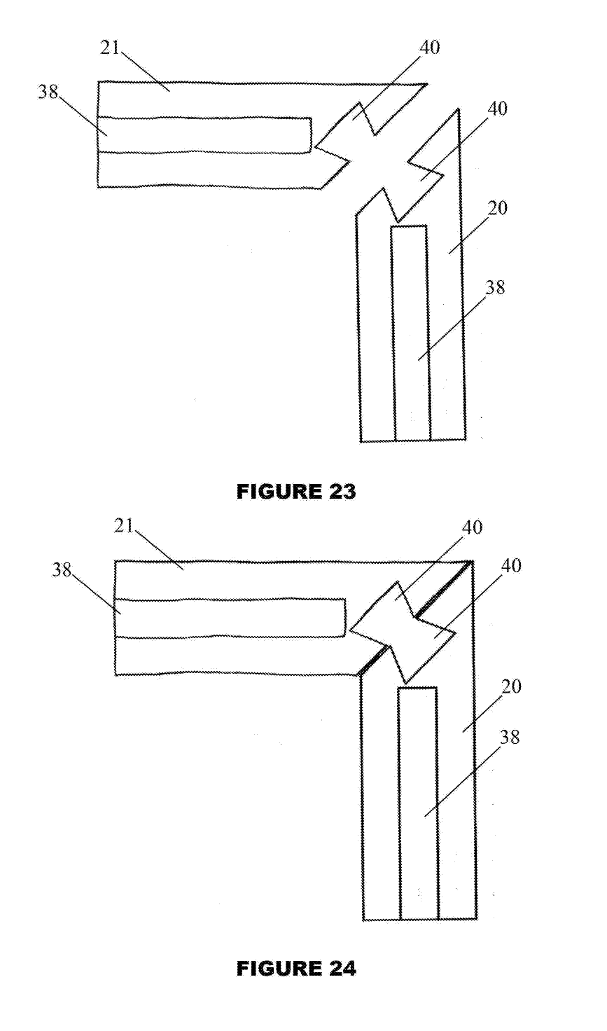

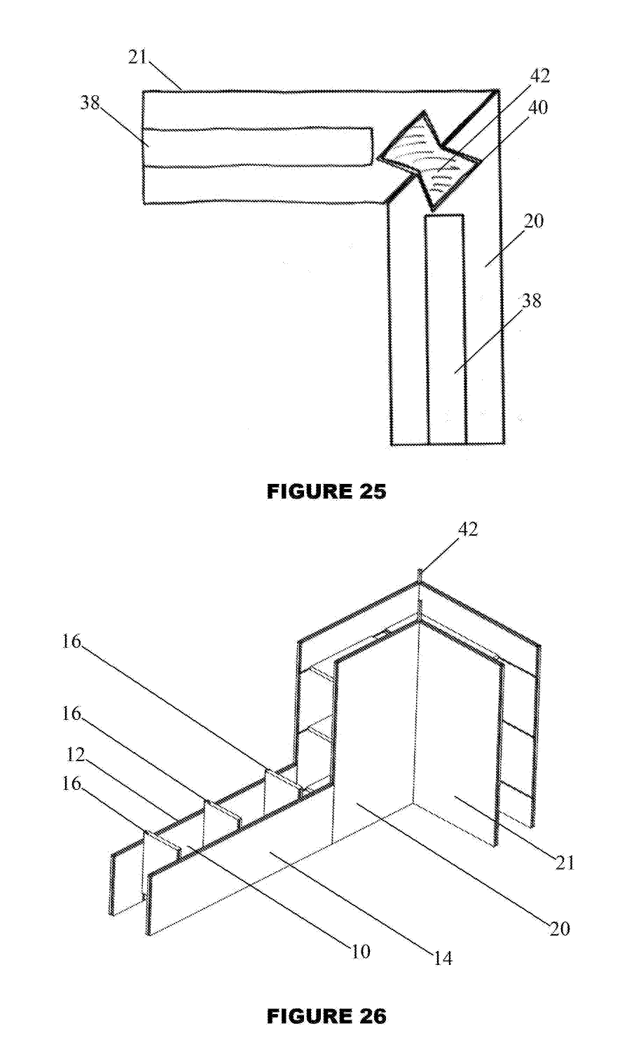

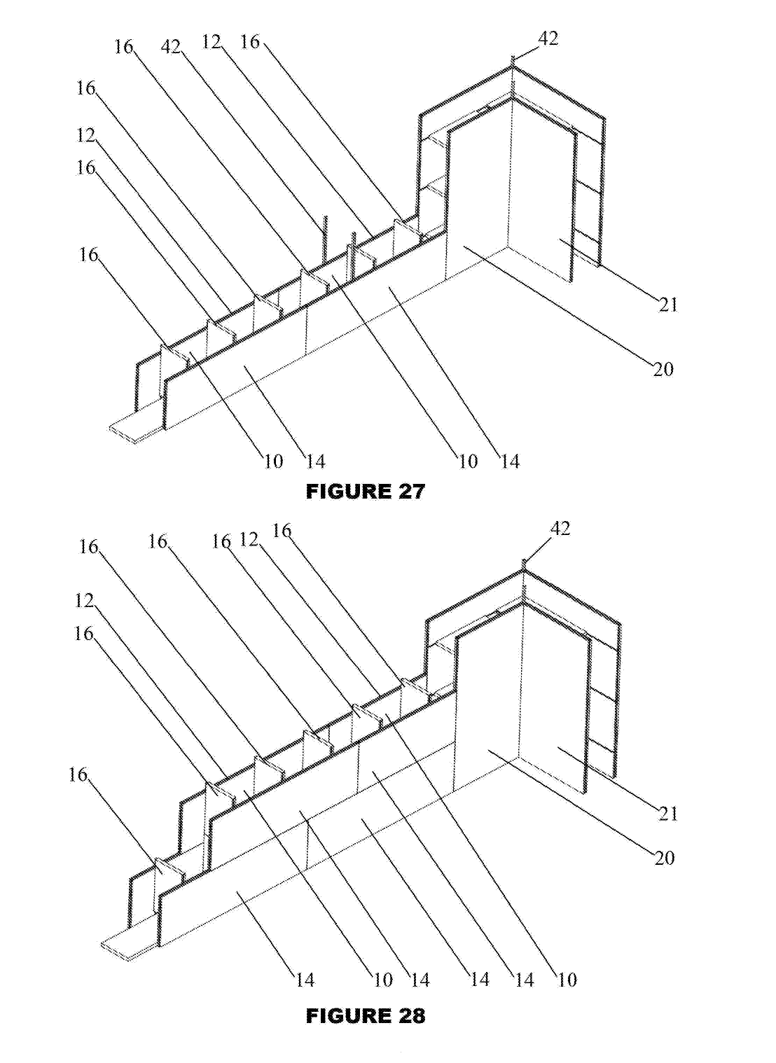

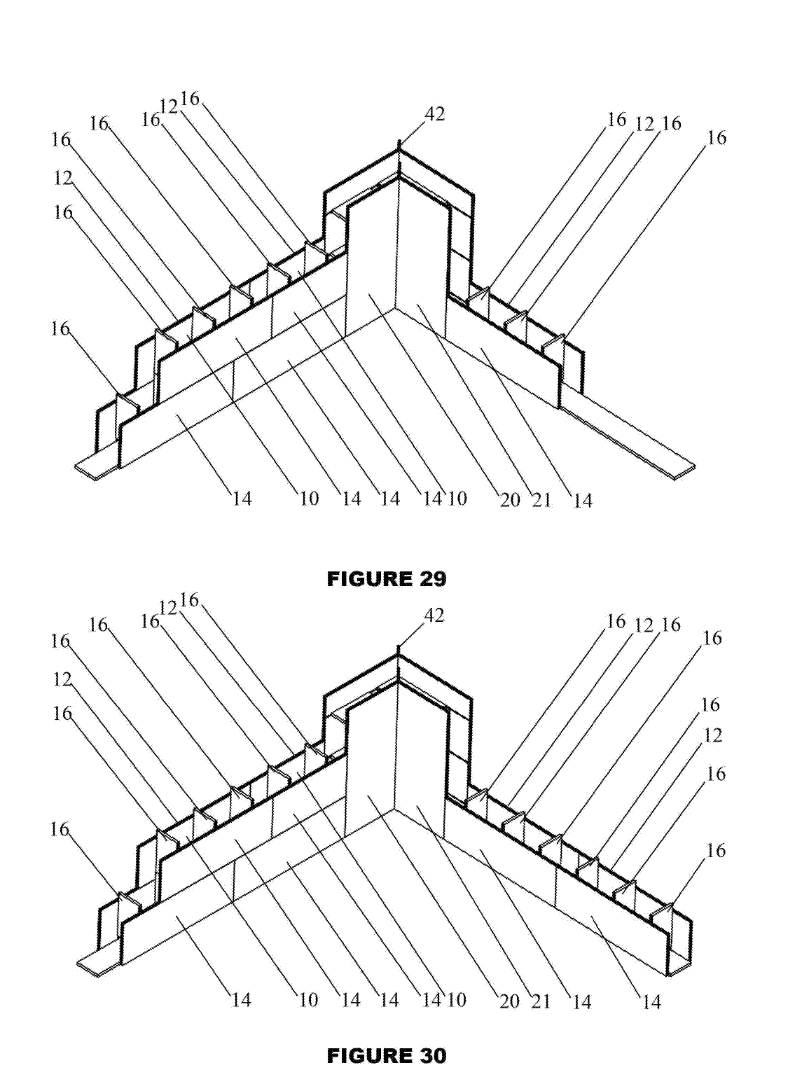

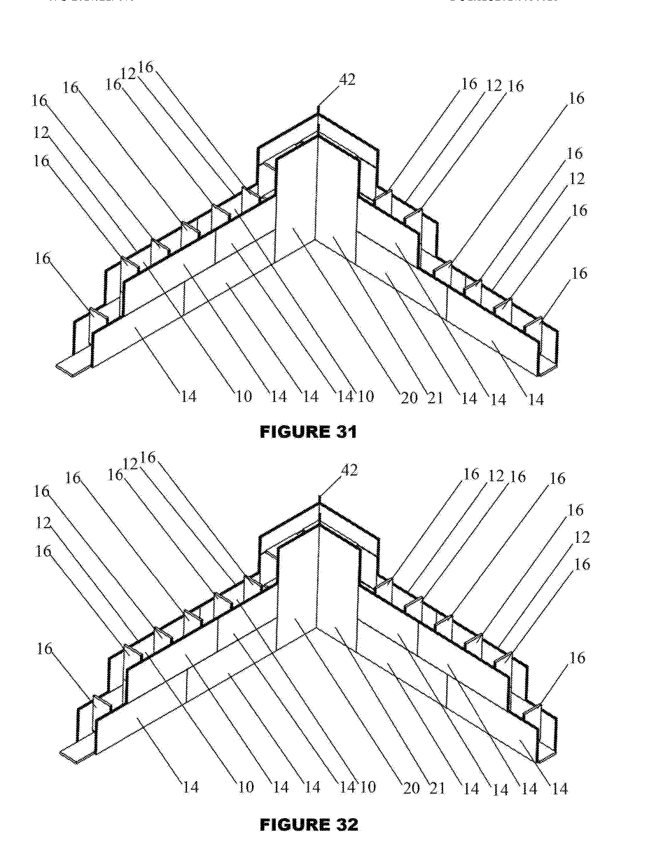

Referring to FIGS. 1 to 41, a preferred embodiment of the invention will be described, where construction apparatus 1 is shown to build wall 5, of construction blocks 10. Multiple block 10 arrangements can be used to create walls 5 of any suitable height or width, through use of the apparatus and method of the invention. Construction apparatus 1, used to build wall 5 can be seen to be an extremely useful construction which utilises tongue and groove between blocks and panels, at their upper and lower extremities, and strong interlocking connecting parts to fix panels firmly together, as explained in greater detail below. We refer to the surface created as a wall, but equally the construction could be manipulated and adapted to create floors, ceilings, trusses, and all kinds of internal walls and parts of buildings, not limited to those described. The invention is so versatile and adaptable that it is able to be used in place of many different forms of conventional construction materials.

Each construction block 10, used to build wall 5, has front panel 12, rear panel 14, and spacer panels 16. Many construction blocks 10, each made of front panel 12, rear panel 14, and spacer panels 16 used repeated to form the construction, through use of tongue and groove construction. Suitable grooves inside panels 12 and 14 at spaced intervals enable spacer panels 16 to be slid in from above to space panels 12 and 14 from one another. The number of spacer panels 16 can be varied to suit the particular application. Panels 12 and 14 with spacer panel 16 form a supported construction. The supported construction is not of sufficient strength at this stage, the interlocking needs to occur to cement the structure together. However, spacer 16 projects above the upper edge of front panel 12 such that another front panel 12 can be slid down onto spacer panel 16. This interplay between the layers assists to hold the structure together during construction, and before being locked in place by use of the interlocking part for that row.

Spacer panels 16 are illustrated as 300 millimetre high and 176 millimetres side, configured to protrude 50 millimetres above the top of panels 12 and 14. Each space panel has a tongue at either end which slide into corresponding grooves on the inner surface of panels 12 and 14 aligned so that space 16 sits straight across. The spaced apart support that spacer panels give between panels 12 and 14 assist to create the strong construction.

As illustrated front panel 12 and rear panel 14 are made of bamboo. Bamboo sheeting is known and any suitable bamboo sheeting may be used for the invention. As described, special engineered bamboo sheeting is used which gives the construction greater strength. The particular form of bamboo sheeting used has been devised by the inventor for maximum strength, and has three layers of 6 millimetres each, the other two with fibres running horizontally, around a central layer with vertical fibres.

The particular form of bamboo sheeting used for the invention is an engineered panel for maximised strength in a lightweight, flexible panel. The method of construction involves steps to harvest bamboo canes, which are then soaked or steamed to remove the sugar, before being oven dried. The oven dried strips are then glued into sheets of three layers, to be engineered to have a central layers each 6 millimetres thick arranged to be vertical and overlapping. The outer two layers are of the same thickness, 6 millimetres but each of these layers runs horizontally. Use of these opposed layers within the fibrous bamboo significantly increases the strength of each bamboo sheet. Each bamboo sheet for making panels 12 and 14 are only 18 millimetres thick after construction but the strength of the engineered panel is very high. As bamboo is a natural fibrous material once formed into sheets in this manner it does not lose its natural flexibility and so the resultant sheet is similarly flexible as well as having superior strength.

Each panel 12 or 14 therefore has a horizontal grain outmost. As illustrated panels 12 and 14 are 800 millimetres long by 300 millimetres high and 200 millimetres wide. These are the full block sizes but as will be apparent there will also be the need for three quarter sized blocks (not shown) (600 millimetres long by 300 millimetres high and 200 millimetres wide), half sized blocks 11 (400 millimetres long by 300 millimetres high and 200 millimetres wide), and quarter sized blocks (not shown) (200 millimetres long by 300 millimetres high and 200 millimetres wide). Other forms and sizes of blocks may be used within the scope of the invention to suit any particular application. The front and rear panels of the other sizes of block are, and are assembled, exactly as for the described full sized block 10.

Each panel 12 or 14 uses tongue and groove construction to build panel on panel with tongues at the lower edge of each panel to correspond to the grooves at the upper edge of each of panels 12 or 14. Adhesive (not shown) is applied to the tongue and groove connected panels.

Capping panel 18 is shown as would be used to finish the upper most surface of wall 5. As illustrated this is a bamboo capping panel 18 of 2400 millimetres by 200 millimetres by 18 millimetres, slid on top of assembled blocks 10 using a tongue and groove arrangement. The tongues (not shown) of capping panel 18 are slid along and into the grooves on the top of panels 12 and 14 to held firmly in place. The tongue and grooves may be reversed as would be understood by a person skilled in the art. In addition to capping panel 18, metal top plate 10 is included of 200 millimetres by 75 millimetres by 10 millimetres, in a suitable steel material. Metal top plate 19 is used for the tie down and final securing of the construction. The invention may be used tied in to any suitable floor. For example, using metal rods through the construction and tied into a standard metal footing in concrete. These may be standard steel 12 millimetre threaded rods, secured and tied into a metal and concrete footing. Other securing to a surface may use fixings, glue for example. The blocks in contact with the floor surface may be adapted to assist with the fixing to the floor. As illustrated additional bamboo strips are placed within the lowest block and secured using nails and glue to the floor below, while metal tie in rods through the construction tie between the metal footing and the top metal plate. In this way the construction assembly 1 is very strongly secured to the footing and movement side to side is acted against, to help maintain the construction in place.

Due to the created strength of the assembly, other finishing or capping, as used in concrete constructions may not be necessary.

In other forms of the invention the construction may not need to be so securely tied in, for example, for a non-supporting division or interior wall. In this case the construction assembly may be simply glued or nailed to the underlying floor which itself may be bamboo, or wood or other materials.

Corner pieces 20/21 and 22/23 are included at either end to show how further walls 5 may be included to build other forms of construction. Repeated corner pieces 20/21 and 22/23 are built up one on top of the other slid together through use of tongue and groove attachments. Corner pieces 20/21 form a right-angle to turn the corner for a wall are orthogonal with a front surface 22 and rear surface 23. For corner pieces a vertical grain may be used or the same format as for the panels. As illustrated the external dimensions of corner pieces 20/21 and 22/23 together are 800 millimetres high by 600 millimetres wide. Corner spacers 24 are used, and these are horizontal in grain of bamboo, as the wall panels 12 and 14, and are sized as illustrated as 176 millimetres by 412 millimetres. Corner spacers 24 work in the same manner as described for spacers 16. These also project above the top of the particular panel to assist the construction of row on row.

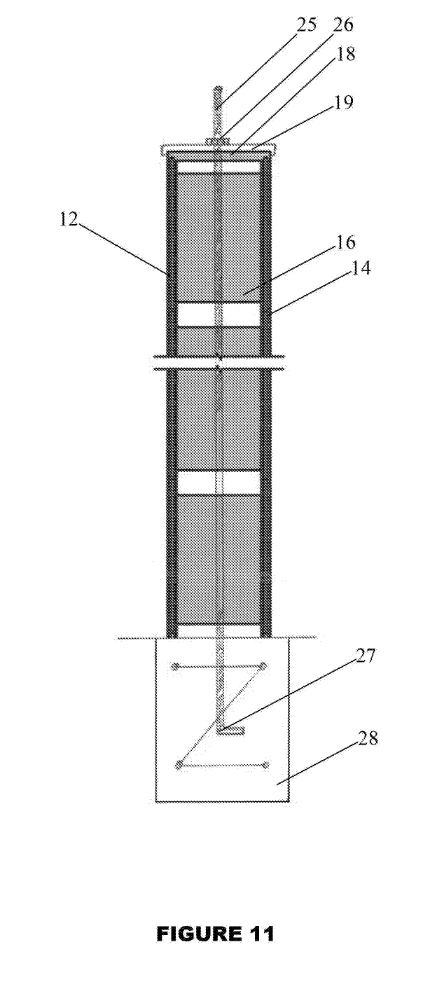

Referring to FIG. 11 in particular, an example of a tie down is shown including metal top plate 19 with metal 12 millimetre threaded rod threaded through the hole in 19 (not labelled) and secured with nut 26. At the other end metal rod 25 forms part or is tied into footing 27, set in a concrete footing 28. The footing formation is known and may be adjusted to depend on the different types of construction arrangement to which construction apparatus 1 is to be attached.

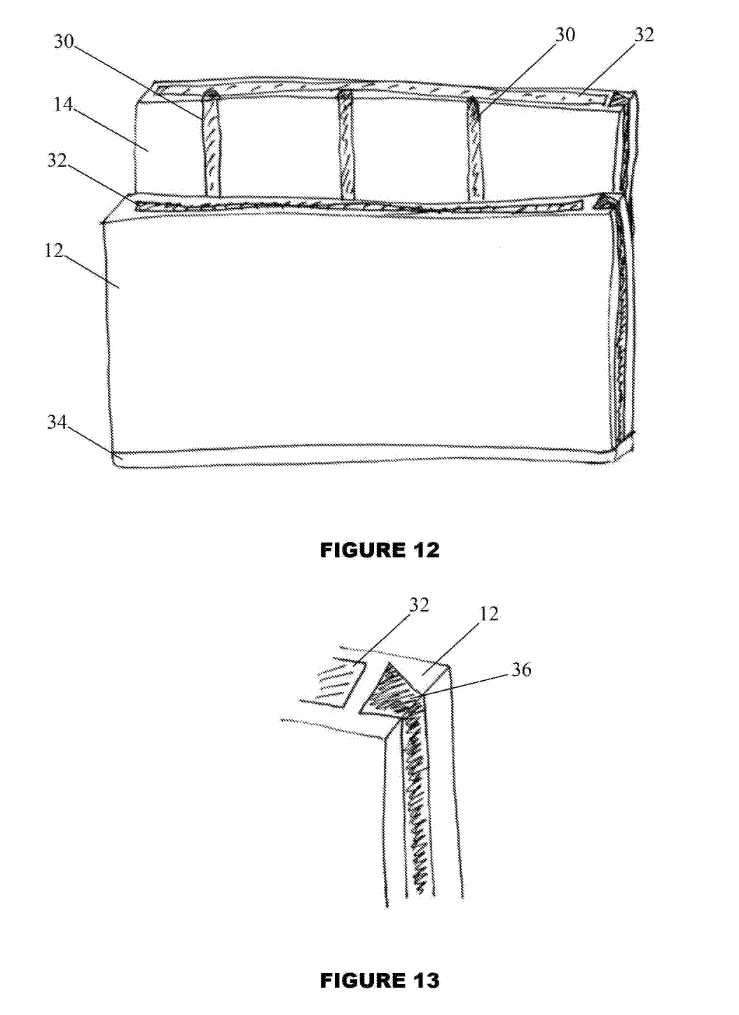

Referring to FIG. 12 in particular, a schematic partially assembled block 10 is illustrated, showing the spaced apart panels 12 and 14 before spacer 16 is put in place. Grooves 30 can be seen on the inside of panel 14, three to each panel, corresponding to the tongue of the tongue and groove panel 16 used as a spacer. There are corresponding grooves on the inside of panel 12 at the same location so that three spacer panels 16 can be slid in during assembly.

Grooves 32 are schematically indicated at the uppermost edge of panels 12 and 14. These are suitable sized to receive tongue 34 as can be seen at the lower edge of panel 12 in FIG. 12. It is through use of grooves 32 and corresponding tongues 34 that multiple panels may be constructed one on top of the other.

Cut-out receiving portion 36 can be seen to form a trapezoid shape from above. The shape is cut-out and continued from top to bottom of each of panels 12 and 14. The cut-out may be formed in any suitable manner during construction of panels 12 and 14. Similarly, groove 38 lies along the top edge of corner pieces 20/21 and 22/23 to again along joining through tongue and groove on reciprocating pieces. Each corner piece 20/21 or 22/23 also includes trapezoid cut-outs 40, the same shape as those in panels 12 and 14. Similarly, the straight ends of the straight pieces of the corner pieces 20/21 22/23 (not shown) also include a cut-out and are connected to block 10 through use of further interlocking parts, in the cut-out of the straight part of the corner part and of the straight parts of the front and back panels.

Interlocking part 42 is important, as it is the same trapezoid shape as formed by two cut-outs of either panels 12 and 14 or corner pieces 20/21 or 22/23 when put together. The forming of the shape can be seen in particular in the sequences of Figures. In these figures it can be seen that the corresponding cut-outs are formed so as to sit together and form the exact cross-sectional shape of interlocking part 42. Interlocking part 42 can therefore be aligned straight above each reciprocating cut-out 36 or 40 and slid in along its length/height. The long strong lock fixes the two panels together as once in place pulling forces in any direction are resisted by the angled shape. The process is repeated across numerous blocks until wall 5 is built.

A summary of the steps of construction may be:—

1. Attach a footing layer to a base or floor (this may be tied in to a concrete footing as shown, but may also be glued and use other fixings in other applications);
2. Sliding pairs of front and rear panels to the footing layer, sliding the tongues of the bottom edges into grooves to be lightly held in place
3. Applying adhesive may be applied during step 2, or afterwards to fix the construction;
4. Sliding spacers into grooves on the inner surface of the front and rear panels to strut the “blocks” formed by the front and back panels.
5. Locating corresponding cut-out portions from adjacent panels and the channel created;
6. Attaching the panels together by sliding the interlocking part into the channel formed by the two cut-outs together so as to be held;
7. Repeating for rows of blocks and across with more panels.

Additional steps may be included such as to cap the top piece, using shortened spacers. Corner pieces may be used at the end and these can be formed and fixed in a similar manner, sliding the pieces into the grooves and then fixing in place through use of the lock and key formation of the channel of the cut-out and the interlocking piece.

The inventor has developed a building material, block and construction method that uses a cheap to produce sustainable product, with a low carbon footprint. Bamboo is flexible and extremely durable and fire resistant and can be treated to resist insects. The resultant construction can be strong enough to meet stringent building standards.

It will be apparent to a person skilled in the art that changes may be made to the embodiment disclosed herein, without departing from the spirit and scope of the invention in its various aspects.

REFERENCE SIGNS LIST:

| | |
|---|---|
| 1 | Construction apparatus |
| 5 | Wall |
| 10 | Construction blocks |
| 11 | Half size construction block |
| 12 | Front panels |
| 14 | Rear panels |
| 16 | Spacer panels for 10 |
| 18 | Capping panel |
| 19 | Metal top plate |
| 20/21 | Corner piece |
| 22/23 | Corner piece |
| 24 | Spacer |
| 25 | Metal rod |
| 26 | Nut |
| 27 | Metal tie in |
| 28 | Concrete footing |
| 30 | Groove (spacer) |
| 32 | Groove (12 and 14) |
| 34 | Tongue |
| 36 | Cut-out (12 and 14) |
| 38 | Groove (20/21, 22/23) |
| 40 | Cut-out (20/21, 22/23) |
| 42 | Interlocking part |

1-64. (canceled)

65. A construction apparatus for building, the construction apparatus including:
a first construction part including a receiving portion, the first construction part being made substantially of a thin composite bamboo material;
a second construction part, including a receiving portion the second construction part being made substantially of a thin composite bamboo material, being an engineered bamboo sheet using thin layers of bamboo fibres substantially arranged as two outer layers of horizontal bamboo fibres surrounding a central layer of vertical bamboo fibres to give the material particular strength for construction;
an interlocking means of bamboo composite formed of an engineered bamboo material and configured to strongly resist damage in all directions, adapted to be received in the receiving portions of the first and second construction parts when put together,
wherein the interlocking means maintains the first construction part and second construction part together, without the need for additional fixings.

66. The construction apparatus of claim 65, wherein the arrangement of bamboo fibres is reversed.

67. The construction apparatus of claim 65, wherein the overall thickness of the bamboo sheet is substantially 18 millimetres.

68. The construction apparatus of claim 65, wherein the first and or second construction parts are substantially rectangular panels, with first and second ends, a top surface and lower surface, and a top edge and lower edge.

69. The construction apparatus of claim 68, wherein each end includes receiving portions for receipt of an interlocking means whereby a plurality of first and second construction parts may be attached together.

70. The construction apparatus of claim 65, wherein front and back panels are used, and these attach to corresponding parts to make “blocks” of a wall.

71. The construction apparatus of claim 65, wherein tongue and groove connections are used between each of the first construction part and second construction part include a tongue at either the top or lower edge and a corresponding groove at the appropriate top or lower edge.

72. construction apparatus of claim 65, wherein the receiving portion lies in at least on end of the first construction part and at least one end of the second construction part.

73. The construction apparatus of claim 72, wherein the receiving portion runs substantially the length of the at least one end of the first construction part, open to the top surface of the first construction part and to the lower surface of the first construction part and the receiving portion runs substantially the length of the at least one end of the second construction part, open to the top surface of the second construction part and to the lower surface of the second construction part.

74. The construction apparatus of claim 65, wherein when a first end of the first construction part and second end of a second construction part are put together the receiving portions in the ends together form a combined receiving portion for receipt of the interlocking means.

75. The construction apparatus of claim 65, wherein the combined receiving portion shape as viewed from above is substantially the same shape in cross-section of the interlocking means.

76. The construction apparatus of claim 75, wherein the combined shape of the receiving means is substantially a “bow-tie” shape as it strongly resists removal in the horizontal direction.

77. The construction apparatus of claim 65, wherein the receiving portion shape repeats as more first and second construction parts are added to create a wall, sheet or surface.

78. The construction apparatus of claim 65, wherein repeats of first and second parts, including spaced apart from one another assist to form a cavity wall.

79. The construction apparatus of claim 65, wherein the receiving portion of the first construction part and the receiving portion of the second construction part are mirror images of one another.

80. The construction apparatus according of claim 65, wherein corner pieces or shaped construction parts may be included as well as straight parts for either the first or second construction part.

81. The construction apparatus of claim 80, wherein the corner parts may abut at an angle to form the combined receiving portion shape, suitable for receipt of the interlocking means.

82. The construction apparatus of claim 65, wherein the interlocking means is configured to fit into the receiving portions of the first and second part together, whereby the parts are held together strongly.

83. A method of use of a construction apparatus, each construction apparatus including, a first construction part including a receiving portion, the first construction part being made substantially of a thin composite bamboo material, a second construction part including a receiving portion, the second construction part being made substantially of a thin composite bamboo material, and an interlocking means of bamboo composite, the method of use including the following steps:
a) aligning a receiving part of the first construction part with a receiving part of second construction part to create a receiving channel;
b) putting the interlocking part into the receiving channel, and
c) repeating steps a) and b) with further first and second construction parts until the construction has been built,
whereby the first and second construction parts are held together without the need for further fixings.

84. The method of claim 83, wherein there is included a step before step a) of placing a pair of first construction parts in a spaced arrangement, whereby a “block” is created and repeated in either the vertical, or horizontal directly with use of more first and second construction parts.
